(19) United States
(12) Patent Application Publication
(10) Pub. No.: US 2018/0279414 A1
(43) Pub. Date: Sep. 27, 2018

(54) INFRARED HEATER

(71) Applicant: Rainer FÖRSTER, Dortmund (DE)

(72) Inventor: Rainer FOERSTER, Dortmund (DE)

(21) Appl. No.: 15/760,508

(22) PCT Filed: Sep. 14, 2016
(86) PCT No.: PCT/EP2016/071668

§ 371 Date: Mar. 15, 2018

(30) Foreign Application Priority Data
Sep. 16, 2015 (DE) 10 2015 115 628.8

(51) Int. Cl. H05B 1/02; H05B 3/00; H05B 3/84; B60S 1/02

(52) U.S. Cl. CPC H05B 1/0236; H05B 3/0042; H05B 2214/02; B60S 1/026; H05B 2203/032; H05B 3/84

(57) ABSTRACT

An infrared heater having at least three infrared emitters arranged in a housing, wherein a solution is created for suffusing as large a solid angle as possible with infrared radiation, wherein the majority of the infrared radiation is emitted in the direction of the space to be heated, and a costly water cooling of the housing can thereby be avoided. This is achieved in that the housing (3) has a front plate, wherein the infrared emitter is oriented in parallel to the front plate and the infrared emitter is oriented transverse to the front plate, wherein the infrared emitters have a flat emission surface, and the greater portion of the occurring infrared radiation is emitted in the direction of the front plate.

The invention relates to an infrared heater having at least three infrared emitters that are arranged in a housing.

Such an infrared heater is known from DE 298 04 666 U1. In this infrared heater, three infrared emitters are arranged in a housing, wherein each infrared emitter is configured cylindrically. The housing consists of five aluminum panels, wherein the face side of the housing has an opening, and the infrared emitters are visible to a user. Such infrared heaters are used for temperature regulation in living spaces, since many people perceive direct heat radiation as being very pleasant. Since the heat energy is not transported by way of the air per convection, but rather by heat radiation, a longer period required to heat the space is eliminated, and the heat is felt immediately.

However, a disadvantage of this infrared heater is the relatively small spatial angle through which the infrared radiation flows. Since the radiation exits primarily from the face-side opening of the housing, such an infrared heater cannot be used to uniformly heat an entire room. A further disadvantage is that the infrared heaters are configured cylindrically and therefore emit the radiation isotropically in all spatial directions. As a result, the housing of the infrared heater is unnecessarily heated up and requires complex water cooling in order to prevent thermal damage. Furthermore, the open face side of the housing is disadvantageous, since the infrared heaters emit not only infrared radiation but also radiation in the visible wavelength range, which radiation causes glare for the user of the infrared heater.

It is the task of the invention to indicate an infrared heater of the type indicated initially, which suffuses the entire space with infrared radiation, if at all possible, and avoids complex water cooling of the housing. Furthermore, the invention has the task of preventing glare for the users caused by the radiation that occurs in the visible range.

This task is accomplished according to the invention, in the case of an infrared heater of the type indicated, with the characteristics of claim 1.

Thereby an infrared heater is made available, which suffuses a particularly large spatial angle with infrared radiation, since the individual infrared emitters are arranged in such a manner that their beams intersect and thereby produce a very divergent overall beam, which is well suited for uniformly heating a living space. Since the individual infrared emitters are designed in such a manner that the main part of the radiation is emitted in the direction of the front plate, the housing heats up hardly at all, so that it is possible to do without complex and expensive water cooling. A preferred design provides, for this purpose, that the infrared heaters have a rectangular basic shape, in other words are not tubes, wherein the main part of the infrared radiation is emitted in the direction of the front plate by way of a planar emission surface. A main part of the radiation is understood to be a proportion of more than 80% of the total radiation power of the individual infrared emitter. The front plate, which can consist of an optical filter, slate or ceramic, absorbs the visible radiation and prevents glare for the user. It is preferably provided that each infrared emitter is configured as a hollow emitter and has a radiation power of approximately 400 W. The infrared emitters can also be made of ceramic.

It is particularly preferred that the housing of the infrared heater has a trapezoid-like layout, wherein the front plate is arranged along the longer base side, and the infrared emitters are arranged on the shorter housing sides. This has the advantage that the infrared heater can easily be affixed in a corner of a room, and consequently suffuses a maximal spatial angle. Since the infrared emitters are arranged on the housing sides, special holders are also eliminated, and the structure of the infrared heater remains compact.

As a particularly advantageous further embodiment, it is provided that infrared reflectors are arranged between the housing sides and the infrared emitters. The small proportion of radiation that is emitted toward the housing is thereby guided in the direction of the front plate. The infrared radiation that is partially reflected back into the housing on the front plate is also guided back to the front plate by way of multiple reflection. Since a greater part of the radiation is transported into the room by means of the infrared reflectors, the efficiency of the infrared heater is increased. It is preferred that the infrared reflectors are configured as corrugated metal sheets.

A further embodiment of the invention provides that the front plate completely absorbs the infrared radiation. As a result, the temperature of the front plate quickly increases, and the plate itself in turn emits infrared radiation. It is advantageous, in this regard, that when the infrared heater is shut off, the front plate continues to emit for a certain period of time, until the stored heat energy in the form of infrared radiation has been emitted. This embodiment is a good possibility for spaces in which users stay for only a short period of time, for example basement spaces.

It is particularly preferred that the front plate partially absorbs the infrared radiation. In this regard, part of the radiation that impacts the front plate is absorbed and another part is transmitted. The absorbed radiation heats the front plate up, wherein this plate itself generates infrared radiation as it cools. The transmitted radiation, on the other hand, propagates in the room and heats the objects situated in it, for example people, housing items or housing walls. This embodiment is excellently suited for living spaces, since immediate heating is guaranteed by means of the transmitted radiation, and when the infrared heater is shut off, the continued emission effect of the front plate is utilized. Furthermore, this infrared heater can also be used in offices, hospitals, churches, schools, universities, production buildings, single-family and multi-family houses.

Furthermore, this embodiment of the infrared heater is an optimal solution for persons with allergies, since the heat is transported by way of radiation for the most part, and no house dust is swirled up during this process. A further benefit of such an infrared heater lies in the medical sector, wherein the heat rays, which penetrate into human tissue by a few millimeters, lead to better perfusion of the tissue and are used in pain therapy, for example.

As a further embodiment of the invention, it is provided that the front plate is completely permeable for infrared radiation. Since the radiation energy can propagate completely and immediately here, this embodiment is advantageous outdoors, so as to achieve rapid warming of persons.

Furthermore, it is preferred that the infrared heater has a cycling circuit, which turns the infrared emitters on and off periodically, wherein the period duration can be freely selected. Overheating of the infrared heater is prevented using the cycling circuit, and in addition, operating costs are saved. The continued emission effect of the front plate is utilized for this purpose. If the front plate reaches a previously determined temperature, which can be clearly determined over the period of irradiation, the infrared emitters shut off and only the radiation of the front plate is emitted to the room. After a certain period of time, the front plate drops below a minimum temperature, and the infrared heater turns on again. Regulation of the period duration can take place by means of a switch that consists of bimetal. If the infrared heater exceeds a predetermined threshold temperature in the housing interior, the bimetallic switch interrupts the power supply to the infrared heater by changing shape. Subsequently, the infrared heater and the switch cool off slightly but not completely. Cooling brings about a further shape change of the switch, which leads to power supply to the infrared heater once again, since the interruption is cancelled out. The threshold temperature can be set either directly on the infrared heater or using an optional wireless remote control. For this purpose, a further switch can be provided, which interrupts the voltage supply circuit when the bimetallic switch contacts the switch. The distance between the two switches can be changed by way of a setting means. The greater the distance between the switches, the higher the threshold temperature.

A further embodiment of the invention provides that the infrared heater has a temperature sensor that transmits the room temperature to the infrared heater, for example wirelessly. The temperature sensor itself can be affixed on the infrared heater or, alternatively, at any desired location in the room. A regulation circuit modulates the cycling circuit in suitable manner, so that the corresponding room temperature occurs, which is predetermined by cell phone or tablet, using an app, for example.

Furthermore, it is preferred that the housing of the infrared heater has ventilation slits. Heated air can escape from the housing interior through the ventilation slots, and can prevent overheating of the infrared heater. Furthermore, a fraction of the infrared radiation can propagate into the living space in unhindered and direct manner.

It is preferably provided that a temperature regulator is arranged in the housing, which regulator regulates the temperature that occurs in the housing. In the case of infrared heaters, which, in contrast to conventional heaters, do not heat the room air, it is not very practical to use the room temperature outside of the infrared heater as a regulation variable. The temperature regulator regulates the temperature in the housing interior in such a manner that the temperature felt by a person who is exposed to the infrared heater reaches an optimal value between 20° and 30°. It was determined in experiments that this optimal range of the sensed temperature occurs when the temperature in the housing interior lies between 90° and 180°. For this reason, the temperature regulator constantly regulates or controls the temperature in the housing in such a manner that it always lies in the range between 90° and 180°. In this regard, it is important to state that the temperature regulator has a suitable sensor for measuring the temperature, and that the entire temperature regulator is disposed between an infrared emitter and the housing, so that the sensor or temperature regulator is not heated up by the infrared radiation, but rather only by the air temperature situated in the housing interior.

A further embodiment of the invention provides that the temperature regulator has a bimetallic switch that interrupts the power supply to the infrared emitters starting from a predefined threshold temperature in the housing interior. In this regard, the threshold temperature lies in the range between 90° and 180°, and can be variably adjusted for the climatic conditions on site.

It is particularly preferably provided that the infrared emitters are not turned on for longer than 20 minutes per hour, so as to use the least possible amount of energy.

A further preferred embodiment provides that the housing has a plastic layer. This plastic layer, which has a lower heat coefficient than metals, which are usual in commerce, is used to ensure that the housing of the infrared heater does not exceed a specific temperature. Here, the idea is that the temperature of the housing does not exceed a temperature of 80° during operation of the infrared heater.

Furthermore, use of an infrared heater according to the invention on or in a motor vehicle is provided. Current motor vehicles utilize the waste heat of the engine to allow heating of the interior of the motor vehicle. Since it is an intention of society that in the near future, a predominant part of motor vehicles will be operated electrically, the question arises as to how such a motor vehicle, which does not produce waste heat, can be heated on cold days without the heating system consuming a major portion of the energy of the rechargeable battery. This problem can be solved by means of the infrared heater according to the invention, which consumes only very little energy to bring the perceived temperature of the vehicle occupants to an optimal value between 16° and 30°.

Furthermore, it is provided that the power supply of the infrared heater occurs by way of a rechargeable battery. This can either be a rechargeable battery of the motor vehicle or an additional rechargeable battery. In the case of an additional rechargeable battery, the infrared heater demonstrates the advantage that it is mobile and can also be used in multiple vehicles.

Furthermore, it can be provided that the infrared heater is directed at the windshield of the motor vehicle. In this way, a windshield covered with snow or ice can be freed from the snow or ice with little energy use and without much effort. In this regard, it can also be provided that the infrared heater is integrated into the dashboard of the motor vehicle.

Nothing was I again put in 2 and 6 Further characteristics, details, and advantages of the invention are evident from the following description and based on the drawings. Objects or elements that correspond to one another are provided with the same reference symbol in all the figures. These show:

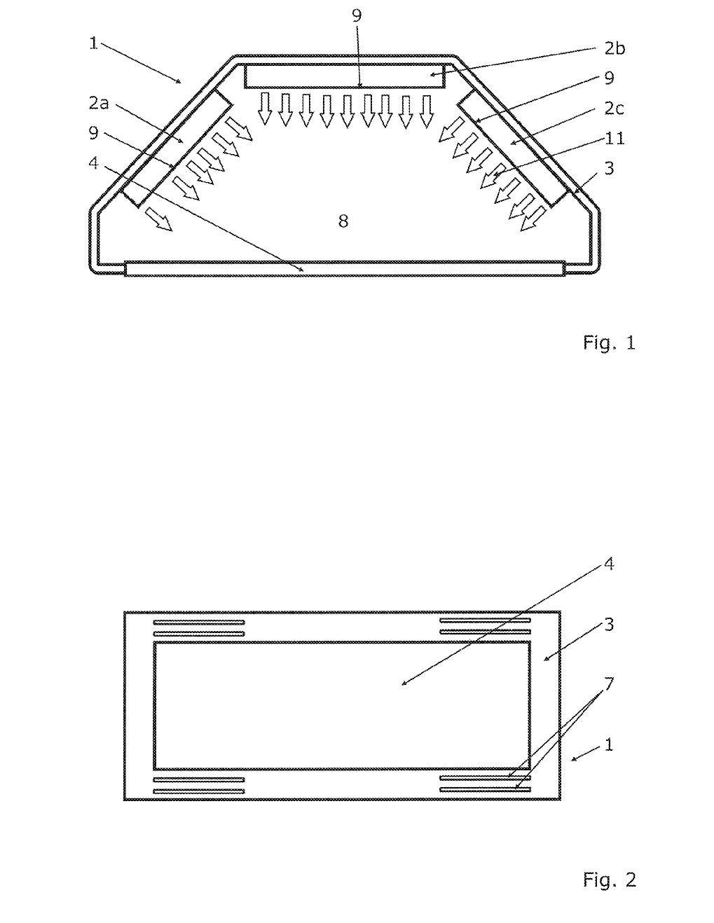

FIG. 1 a top view of an infrared heater according to the invention, wherein the upper housing lid is not shown,

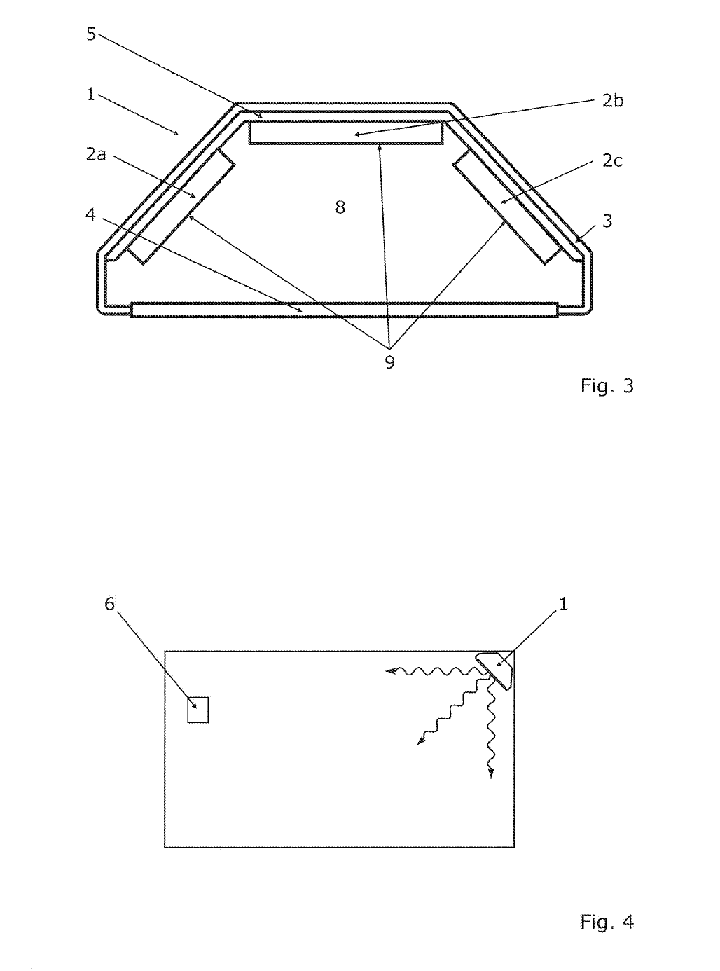

FIG. 2 a side view of the face side of an infrared heater according to the invention,

FIG. 3 a top view of an infrared heater according to the invention, having infrared reflectors, wherein the upper housing lid is not shown,

FIG. 4 a possible arrangement of the infrared heater according to the invention in an example of a living space, and

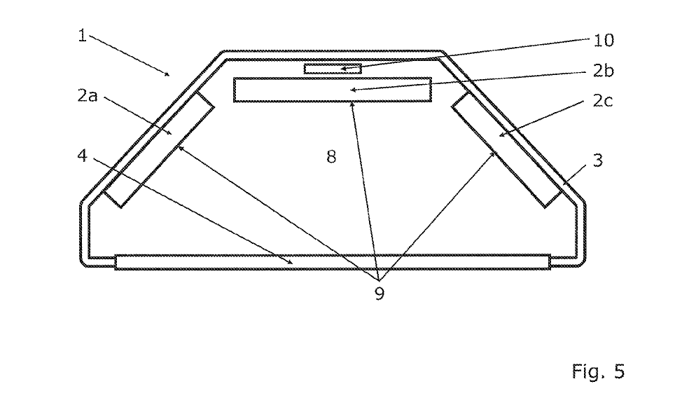

FIG. 5 a top view of an infrared heater according to the invention, with a built-in temperature regulator, wherein the upper housing lid is not shown.

In FIG. 1, an infrared heater 1 according to the invention is shown, which has three infrared emitters 2a, 2b, 2c, a housing 3, and a front plate 4. The housing 3 has a trapezoid-like layout, wherein the housing sides that run toward the longer base side are truncated. The front plate 4 is disposed along the longer base side, and the infrared emitters 2a, 2b, 2c are arranged on the shorter housing sides in the interior of the housing 3. Furthermore, the housing 3 has ventilation slits 7, which are shown as examples in the side view of the face side of the infrared heater 1 in FIG. 2.

The infrared radiation 11 propagates in the housing interior 8 from the infrared emitters 2a, 2b, 2c, and impacts the front plate 4 primarily at an intersection point, wherein a fraction of this radiation is reflected at the surface of the front plate 4. The arrangement of the infrared emitters 2a, 2b, 2c, and the geometry of the housing 3 lead to the result that this reflected radiation is guided to the front plate 4 once again. In this regard, the use of infrared reflectors 5, which further support this effect, proves to be particularly advantageous. Such a structure is shown in FIG. 3, wherein infrared reflector 5 is arranged between the housing 3 and the infrared emitters 2a, 2b, and 2c. Alternatively, each infrared emitter can be provided with its own infrared reflector 5.

In FIG. 4, a possible arrangement of the infrared heater 1 according to the invention in an exemplary living space shown. Because of the special geometry of the housing 3, such an infrared heater 1 can be optimally placed in corners of the room. A temperature sensor, which is disposed at any desired location in the room, wirelessly transmits the measured room temperature to the infrared heater 1, which regulates the room temperature using this information.

Since the radiation from the infrared heater 1 is emitted at a large spatial angle, most of the room walls are heated directly. Room walls that are not situated within the spatial angle of the infrared heater 1 are heated by means of multiple reflection of the beams, since the radiation is not completely absorbed by a single room wall and part is reflected. An isotropic heat distribution in the room occurs due to this effect. Thereby formation of condensation water on cold room walls is prevented, and this in turn prevents the formation of mold, which is hazardous to health.

In FIG. 5, a top view of an infrared heater 1 according to the invention, having a built-in temperature regulator 10, is shown, wherein the upper housing lid is not shown. In this exemplary embodiment, the temperature regulator 10 is arranged between the infrared heater 2b and the housing 3. Thus the temperature regulator 10 is not heated by the infrared radiation itself, but rather essentially by the heated air in the housing interior 8. It is also conceivable that the temperature regulator 10 is arranged between the housing 3 and one of the other infrared emitters 2a or 2b.

Of course, the invention is not restricted to the exemplary embodiments shown. Further embodiments are possible without departing from the fundamental idea of the invention. Of course, power cables from the infrared heater to an external power source are provided; these are not shown. Furthermore, batteries, solar systems, photovoltaics or cogeneration units can also be used to supply power. It is preferred that power supply from regenerative energies is used, such as bio-energy, geothermal heat, water power, ocean energy, solar energy, and wind energy. Furthermore, the infrared heater has a suitable holder so that it can be fastened to a room wall, which holder is not shown.

### REFERENCE SYMBOL LIST

1 infrared heater

2a infrared emitter

2b infrared emitter

2c infrared emitter

3 housing

4 front plate

5 infrared reflector

6 temperature sensor

7 ventilation slit

8 housing interior

9 emission surface

10 temperature regulator

11 infrared radiation

1. Infrared heater (1) having at least three infrared emitters (2a, 2b, 2c) that are arranged in a housing (3),
wherein
the housing (3) has a front plate (4), wherein the infrared emitter (2b) is oriented parallel to the front plate (4) and the infrared emitters (2a, 2c) are oriented at a slant relative to the front plate (4), wherein the infrared emitters (2a, 2b, 2c) have a planar emission surface (9) and emit the major portion of the infrared radiation (11) that occurs in the direction of the front plate (4).

2. Infrared heater according to claim 1,
wherein
the housing (3) has a trapezoid-like layout, wherein the front plate (4) is arranged along the longer base side, and the infrared emitters (2a, 2b, 2c) are arranged on the shorter housing sides.

3. Infrared heater according to claim 1,
wherein
infrared reflectors (5) are arranged between the housing sides and the infrared emitters (2a, 2b, 2c).

4. Infrared heater according to claim 3,
wherein
the infrared reflectors (5) are configured as corrugated metal sheets.

5. Infrared heater according to claim 1,
wherein
the front plate (4) completely absorbs the infrared radiation.

6. Infrared heater according to claim 1,
wherein
the front plate (4) partially absorbs the infrared radiation.

7. Infrared heater according to claim 1,
wherein
the front plate (4) is completely permeable for infrared radiation.

8. Infrared heater according to claim 1,
wherein
the infrared heater (1) has a cycling circuit, which turns the infrared emitters (2a, 2b, 2c) on and off periodically, wherein the period duration can be freely selected.

9. Infrared heater according to claim 1,
wherein
the infrared heater (1) has a temperature sensor (6) that transmits the room temperature to the infrared heater (1).

10. Infrared heater according to claim 9,
wherein
the infrared heater (1) has a regulation circuit that keeps the room temperature constant.

11. Infrared heater according to claim 1,
wherein
the housing (3) has ventilation slits (7).

12. Infrared heater according to claim 1,
wherein
a temperature regulator (10) is arranged in the housing (3), which regulator regulates the temperature that occurs in the housing (3).

13. Infrared heater according to claim 12,
wherein
the temperature regulator (10) has a bimetallic switch that interrupts the power supply to the infrared emitters (2a, 2b, 2c) starting from a predefined threshold temperature in the housing interior (8).

14. Infrared heater according to claim 1,
wherein
the infrared emitters (2a, 2b, 2c) are not turned on for longer than 20 minutes per hour.

15. Infrared heater according to claim 1,
wherein
the housing (3) has a plastic layer.

16. Use of an infrared heater according to claim 1 in a motor vehicle.

17. Use of an infrared heater according to claim 16,
wherein
the power supply to the infrared heater occurs by way of a rechargeable battery.

18. Use of an infrared heater according to claim 16,
wherein
the infrared heater is directed at the windshield of the motor vehicle.
